(19) United States
(12) Patent Application Publication
(10) Pub. No.: US 2005/0285756 A1
(43) Pub. Date: Dec. 29, 2005

(54) Audible vehicle safety device

(76) Inventor: Andrew Shwak, Perkasie, PA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/166,708

(22) Filed: Jun. 24, 2005

Related U.S. Application Data
(60) Provisional application No. 60/582,729, filed on Jun. 24, 2004.

(51) Int. Cl. G08G 1/16

(52) U.S. Cl. 340/903; 340/435; 340/438

(57) ABSTRACT

An audible voice reminding device which is first activated the time after the cars ignition switch is turned on, and plays a recording reminding the driver to stay or drive on the left or right side of the road, depending on the country the driver is in. This device will replay the recording at preset times continuously while the care or vehicle is in operation always reminding the driver as to not forget to stay on the correct side of the road. The recording will also work by detecting that the car is making a turn or speed and motion changes; for example at an intersection or leaving a parking lot and play the voice recording. This can also be enhanced to receive input from a GPS system.

### CROSS REFERENCE TO RELATED APPLICATIONS

This application claims benefit to provisional application 60/582,729, filed Jun. 24, 2005, entitled “Audible Vehicle Safety Device”, which is incorporated by reference herein in its entirety.

### FIELD OF THE INVENTION

This invention relates to driver safety and particularly to situations where drivers need to drive in a country where the driver's side of the road is different from the driver's home country.

### BACKGROUND OF THE INVENTION

Most countries of the world such as the United States and Canada have their roadway systems set up such that drivers drive on the right side of the road. The United Kingdom, Republic of Ireland and many former British colonies in the Caribbean, Asia and Africa have been set up so that drivers drive on the left side of the road. Each year dozens of people are killed or injured on vacations and trips due to their unfamiliarity with local driving customs and laws.

There have been many documented cases where foreign drivers have been involved in vehicle accidents because they forgot to drive on the proper side of the road. It can be very disorientating while driving in a country that has driving rules opposite to the driver's home country, and can easily lead to serious or fatal collisions. At present there are no simple devices or systems to remind foreign drivers to stay on the correct side of the road. The Irish Insurance Federation claims that between 10% and 15% of accidents involved hired or rented cars that are results of tourists being on the wrong side of the roads.

Some countries have approached the problem by the doubling of road signage to remind foreign drivers to stay on the correct side of the road. Also research has been done to develop a system implanted in roads to sense drivers who may be on the wrong side of the road. This is a very expensive solution. Car insurance in these areas tends to be very costly because of this problem.

A number of patents have issued on technologies of driver safety. None have addressed the precise issue of protecting foreign drivers who may inadvertently be traveling on the wrong side of the road. U.S. Published Application No. 2004/0022416 A1 discloses a system and method which assists the drivers of a motor vehicle in preventing accidents or minimizing the effects of the same. In one form, a television camera is mounted on a vehicle and scans the roadway ahead of the vehicle as the vehicle travels. Continuously generated video picture signals output by the camera are electronically processed and analyzed by an image analyzing computer, which generates codes that serve to identify obstacles. A decision computer mounted in the controlled vehicle receives such code signals along with code signals generated by the speedometer or one or more sensors sensing steering mechanism operation and generates control signals. Such control signals may be displayed, and a synthetic speech or special sound generating and warning means used, to warn the driver of the vehicle of approaching and existing hazards. The system may also use the control signals, particularly through application of fuzzy logic, to control signals, particularly through application of fuzzy logic, to control the operation of the brakes and steering mechanism of the vehicle to avoid or lessen the effects of a collision. In a particular form, the decision computer may select the evasive action taken from a number of choices, depending on whether and where the detection device senses other vehicles or obstacles.

U.S. Pat. No. 6,498,972 B1 discloses a control system for an automotive vehicle which has a remote object sensor that generates an object signal in the presence of an object. A vehicle trajectory sensor generates a signal indicative of the vehicle traveling on a curved road. A vehicle speed sensor generates a speed signal corresponding to the longitudinal speed of the vehicle. A controller is coupled to the object sensor, the vehicle trajectory sensor, and the vehicle speed sensor. When the remote object sensor indicates the presence of an object with a minimum cross section in a pre-defined decision zone meeting pre-defined relative velocity criteria, and when the vehicle speed is above a first threshold and below a second threshold, and when said vehicle trajectory signal indicates the vehicle traveling on a curved road with a radius of curvature above a threshold value, a vehicle safety countermeasure system 940) is deployed.

U.S. Pat. No. 6,226,389 B1 discloses a system and method to assist the driver of a motor vehicle in preventing accidents or minimizing the effects of same. In one form, a television camera is mounted on a vehicle and scans the roadway ahead of the vehicle as the vehicle travels. Continuously generated video picture signals output by the camera are electronically processed and analyzed by an image analyzing computer, which generates codes, that serve to identify obstacles. A decision computer mounted in the controlled vehicle receives such code signals along with sensors sensing steering mechanism operation and generates control signals. Such code signals may be displayed, and as synthetic speech or special sound generating and warning means used to warn the driver of the vehicle of approaching and existing hazards. The system may also use the control signals, particularly through application of fuzzy logic, to control the operation of the brakes and steering mechanism of the vehicle to avoid or lessen the effects of a collision. In a particular form, the decision computer may select the evasive action taken from a number of choices, depending on whether and where the detection device senses other vehicles or obstacles.

U.S. Pat. No. 6,553,130 B1 discloses a system and method which assists the driver of a motor vehicle in preventing accidents or in minimizing the effects of the same. In one form, a television camera is mounted on a vehicle and scans the roadway ahead of the vehicle as the vehicle travels. Continuously generated video picture signals output by the camera are electronically processed and analyzed by an image analyzing computer, which generates codes that serve to identify obstacles. A decision computer mounted in the controlled vehicle receives such code signals along with code signals generated by the speedometer or one or more sensors sensing steering mechanism operation and generates control signals. Such code signals may be displayed, and a synthetic speech or special sound generating and warning means used, to warn the driver of the vehicle of approaching and existing hazards. The system may also use the control signals, particularly through application of fuzzy logic, to control the operation of the brakes and steering mechanism of the vehicle to avoid or lessen the effects of a collision. In a particular form, the decision computer may select the evasive action taken from a number of choices, depending on whether and where the detection device senses other vehicles or obstacles.

U.S. Pat. No. 5,545,960 discloses the present apparatus, control system, and method for navigating is used to navigate a mobile machine accurately along a traced path so that the machine avoids collisions with obstacles. Intermediate control outputs are generated no only in accordance with a signal indicative of a distance and angle from a path to be traced according to a navigation procedure for path tracing, but also in response to a signal related to the obstacle-free space ahead of the machine according to a navigation procedure for obstacle avoidance. Weighting coefficients respective for the two procedures are generated by fuzzy inference based on signals indicating the distance and angle from the predetermined path and signals related to the obstacle-free space ahead of the machine. Final control outputs are computed in accordance with the two intermediate outputs and the two weighting coefficients. Regardless of the number of obstacles a mobile machine comes across while moving along a path, and of whether or not they are moving, the mobile machine can avoid them reliably and smoothly.

U.S. Pat. No. 5,913,919 discloses an improved method for the orientation of autonomous mobile units is provide. Collision distances to obstacles are thereby calculated on the basis of the steering and drive geometry of the movable unit. On the basis of these distances, allowed steering angle ranges for the unit are defined. Additionally, a defined observation horizon is prescribed for the sensor equipment of the unit. The obstacles to be evaluated are within this horizon. Moreover, a safety zone is defined around the unit in which no obstacles can be located; otherwise, travel in reverse is triggered. For route optimization of the unit, steering angle ranges that derive from different observation horizons and safety zones are combine on a case-by-case basis. By reducing the safety margin only in narrow passages down to the housing contour of the unit in the extreme case, the maximum steering angle can be utilized. As a result thereof, a greatest possible degree of maneuverability is also assured between obstacles residing close to one another.

While there are a number of systems which warn drivers, all are technically complex and none are directed to a simple system which is directed to keeping foreign drivers on the proper side of the road. If there were a means to audibly remind the driver of the vehicle to stay on the correct side of the road, it would considerably lower the chances of accidents caused by this problem.

It is an object of the present invention to provide a system which warns drivers to stay on the proper side of the road.

It is a further object of the present invention to provide a system which is coupled to the vehicle's steering system which warns drivers to stay on the proper side of the road.

It is still another object of the present invention to warn drivers to stay on the proper side of the road when a preset speed is exceeded.

It is still a further object of the present invention to provide a system in which a warning may be played when a vehicle is on a circle.

These and other objects of the present invention will become apparent from the summary and detailed description which follows.

### SUMMARY OF THE INVENTION

The present invention is directed to a simple system which may comprise a dashboard or internally mounted audible voice reminding device to reduce fatalities involving foreign drivers. This device will include a message to be heard by the motorist and which provides a periodic reminder to stay on the correct side of the road. The driver could always pay attention to operating the vehicle with both hands on the wheel and both eyes on the road; not having to read many road signs telling them to stay on the correct side of the road. The only thing needed is to listen to the device while driving thus reminding them as to which side of the road they should be on.

The reminding device could in one embodiment sense changes in the steering system or degrees of turn and stopping, slowing or motion of the vehicle and play a message to be heard by the motorist. The invention will thus reduce the probability of foreign drivers being involved in accidents. The present invention is thus directed to a system for alerting a driver when he or she moves off of the proper road area. It is a particular object of the present invention to provide a system which permits drivers to be warned if they are driving on the wrong side of the street.

In accordance with the invention, a system for alerting drivers when to remain on the proper side of the road comprising: a sensor affixed to the steering system of a vehicle and for outputting a signal when the vehicle turns past a predetermined point; a processor in communication with the sensor for outputting a signal when the sensor activates; an audio system under the control of processor for alerting the driver to stay on the proper side of the road.

In a further embodiment, the invention is a system for alerting drivers when to remain on the proper side of the road comprising: a sensor in communication with the direction of a vehicle and for outputting a signal when the vehicle turns past a predetermined point; a processor in communication with the sensor for outputting a signal when the sensor activates; an audio system under the control of processor for activating and alerting the driver to stay on the proper side of the road.

In still a further embodiment, the invention is a system for alerting drivers when to remain on the proper side of the road comprising: a sensor affixed to GPS system for outputting a signal when a vehicle turns past a predetermined angle; a processor in communication with the sensor for outputting a signal when the sensor activates; an audio system under the control of the processor for providing an audio signal to the driver to stay on the proper side of the road.

In yet a further embodiment, the invention is a system for alerting drivers when to remain on the proper side of the road comprising: an electronic sensor connected to the steering system of a vehicle and for outputting an electronic signal when the vehicle turns past a predetermined point; a processor in communication with the sensor for outputting a signal when the sensor activates; an audio system under the control of processor for alerting the driver by a verbal message to stay on the proper side of the road.

### BRIEF DESCRIPTION OF THE DRAWINGS

FIG. 1 is a block diagram of a preferred embodiment.

FIG. 2 illustrates a further block diagram view of a system in accordance with the invention.

FIG. 3 shows a vehicle dashboard and steering wheel with an audible device mounted on the underside.

FIG. 4 illustrates the system at a crossroads intersection.

FIG. 5 illustrates the use of the system at a fork in the road.

FIG. 6 is a circle intersection otherwise known as a roundabout in Ireland and England.

FIG. 7 illustrates a parking lot and its entrance or exit onto a road.

### DETAILED DESCRIPTION OF THE PRESENT INVENTION

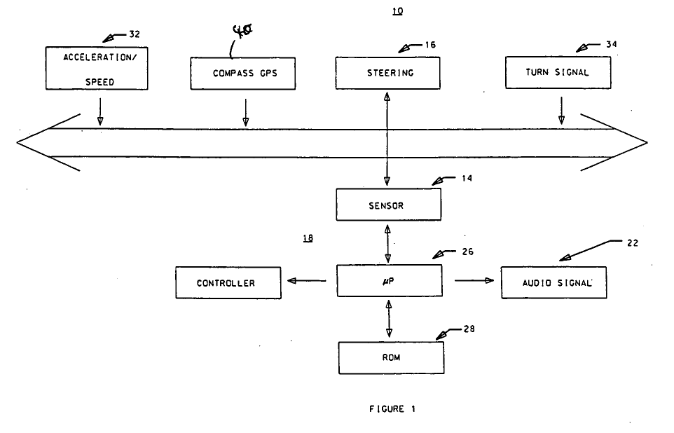

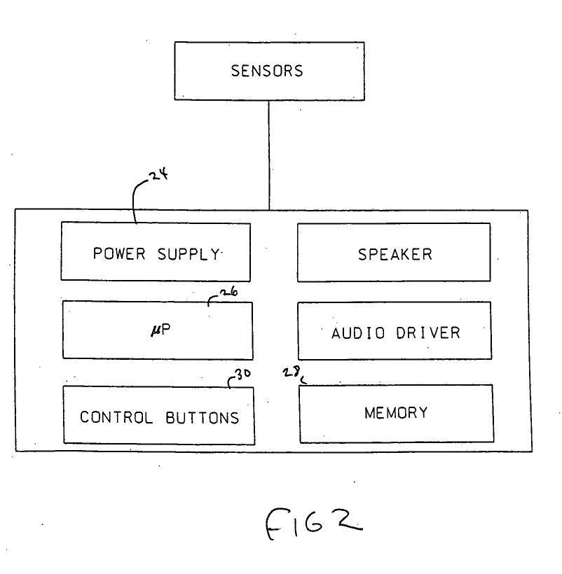

The present invention is directed to a system which permits and facilitates the safety of drivers who are unfamiliar with the driving customs of a particular country or region, and particularly, the proper side of the road for driving. Referring to FIGS. 1 and 2, in a most preferred embodiment, the present invention comprises a sensor system 10 which is intended to activate at predetermined periods when the risk for wrong way driving is the greatest.

In one embodiment, the sensor system may be connected to the steering system 12 of a vehicle such as a truck, car, van or recreational vehicle. In a most preferred embodiment, the present invention comprises a sensor 14 affixed to the steering system 16 of a vehicle. In one embodiment, the sensor 14 is designed to sense when the steering system has turned the vehicle (left or right) a pre-designated number of degrees (e.g., 30 degrees).

When the predetermined number of degrees have been turned, the sensor signals a microprocessor based control system 18. The control system 18 then actives an audio signal to alert the driver to remain on the proper side of the road. The audio signal 22, in a most preferred embodiment, will output a voice signal in a language recognizable to the driver. The prerecorded voice message may inform the driver “drive on the left/right side of the road.” The audio system and signal may be connected to the vehicle's radio system as shown in FIG. 3.

As shown in FIGS. 2 and 3, the system can comprise a separate box or module 21 affixed under the vehicle dashboard. As shown in FIG. 3, the module includes a power supply 24, microprocessor 26 and memory 28. The box module may have any number of control buttons 30. These buttons 30 will be used to program or set the system and to facilitate the language of the system, e.g. English, French, German, Spanish, etc. The memory 28 pre-stores a plurality of messages in various foreign languages which are pre-stored and operate under a number of simple software modules. Control buttons can also select the frequency of the messages and number of times to play during a cycle (e.g., 1, 2, or 3).

In a further embodiment, the signal can also be connected to the speedometer and activated when the vehicle speeds past a predetermined speed 32. The speed can correspond to those speeds associated with four lane highways (e.g., greater than 45 mph), in which passing typically occurs. When the vehicle advances to the pre-selected speed, a message will be played periodically reminding the driver to “stay right (left) pass right (left).” Moreover, the system can also be set up to operate when the vehicle's turn signal 34 is activated. If a left hand turn signal is activated, a voice activated message is played reminding the driver to stay on the proper side of the road after the turn. The system can be programmed and set to activate at predetermined intervals, e.g., every five, seven or ten minutes.

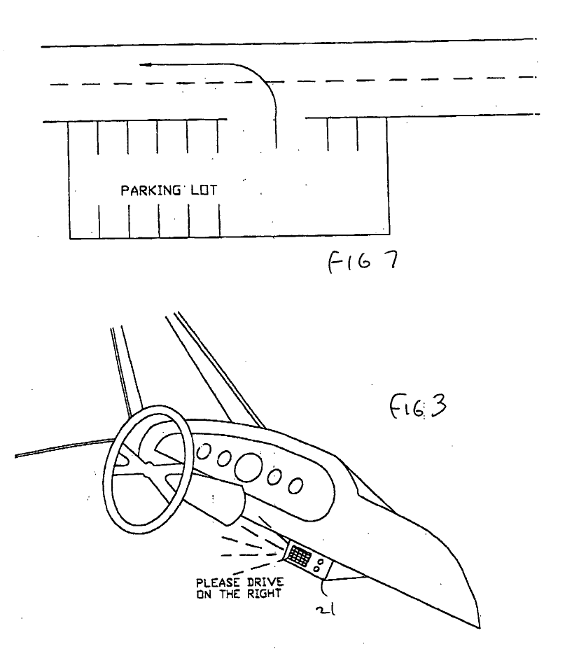

Referring to FIGS. 4 to 7, the operation of the invention is shown in the context of a series of intersections and driving conditions. FIG. 4 shows a crossroads intersection in which traffic lights or a stop sign 40 may be found. If a foreign driver needs to make a left hand turn he could easily become confused as to which side of the road they need to be on after making the turn. In the most preferred embodiment, at this point, the system senses the steering wheel turning so many degrees and play a reminder to the driver of which side he needs to stay on. If the driver is from the United Kingdom, the audible reminder will warn the driver to stay to the right in English. The sensor in the steering wheel upon picking up approximately 30 degrees of turn would send a signal to an associated unit, which plays a recording or digital message. The message may be repeated a pre-selected number of times. In FIG. 5, a driver approaching a fork in the road would need a reminder either in the turn or before making the turn. As noted, the recorded message may be pre-set to be played at predetermined intervals so as to always remind the driver as to which sides of the road on which to stay.

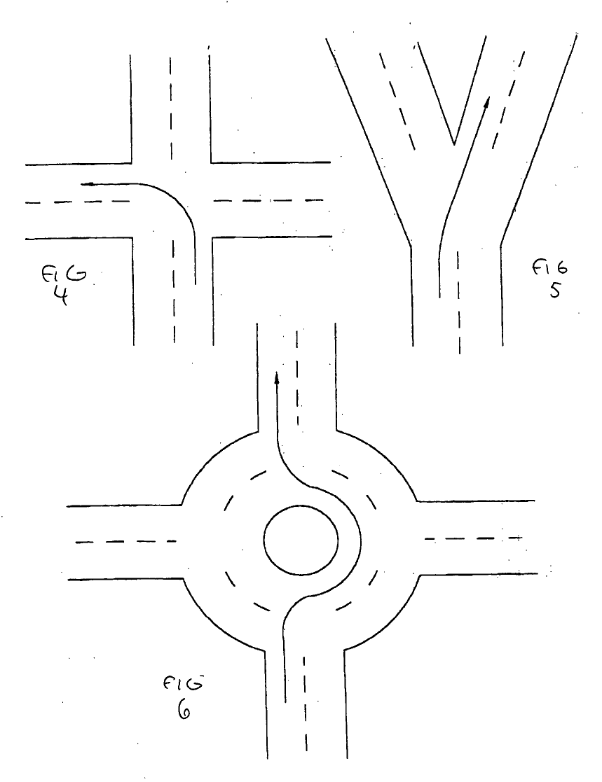

FIG. 6 is a traffic circle (illustration) in which the safety message will be played many times in succession due to the nature of confusion which comes about while attacking the driver situation. In this case, the invention senses the steering wheel is remaining in a turning position and plays the message repeatedly. When the steering system returns to the regular position, the processor will receive a signal and the audible signal will be terminated.

FIG. 7 shows a parking lot and that a driver's intent is to make a left turn out of it. In this example, the driver needs to be reminded before they even leave the lot. At this point, the device would get a signal that the vehicle has just started to move from a standstill or slow moving position and thus play the audible signal.

In a further embodiment, a compass or GPS system 40 may be used. The system notes an original direction or position maintained for a period of time for the vehicle. When a vehicle turns a pre-determined number of degrees, the warning is again activated.

As noted in FIG. 2, the present invention can be programmed to operate in a number of languages. The message could be set by the vehicle rental company or the purchaser of the audible reminding device. The system can be sold as an after market product. Possible messages played are as follows: “Please drive on the left (right) side of the road and pass right.” “Please stay to the right.” “Stay on the left side of the road please.” “Drive on the right.”

The present invention has been described with reference to the attached preferred embodiment. It is to be appreciated that the true nature and scope of the present invention is to be determined with reference to the attached claims.

1. A system for alerting drivers when to remain on the proper side of the road comprising:
a sensor affixed to the steering system of a vehicle and for outputting a signal when the vehicle turns past a predetermined point;
a processor in communication with the sensor for outputting a signal when the sensor activates;
an audio system under the control of processor for alerting the driver to stay on the proper side of the road.

2. The system of claim 1 wherein the audio system plays a voice recorded message.

3. The system of claim 3 wherein the voice recorded message can be programmed in a plurality of languages.

4. The system of claim 1 wherein the signal is output when the steering system turns about thirty degrees.

5. A system for alerting drivers when to remain on the proper side of the road comprising:
a sensor in communication with the direction of a vehicle and for outputting a signal when the vehicle turns past a predetermined point;
a processor in communication with the sensor for outputting a signal when the sensor activates;
an audio system under the control of processor for activating and alerting the driver to stay on the proper side of the road.

6. A system for alerting drivers when to remain on the proper side of the road comprising:
a sensor affixed to GPS system for outputting a signal when a vehicle turns past a predetermined angle;
a processor in communication with the sensor for outputting a signal when the sensor activates;
an audio system under the control of the processor for providing an audio signal to the driver to stay on the proper side of the road.
